(19) United States
(12) Patent Application Publication
(10) Pub. No.: US 2024/0212654 A1
(43) Pub. Date: Jun. 27, 2024

(54) DETUNING DEVICE FOR A STRING INSTRUMENT, AND STRING INSTRUMENT

(71) Applicant: Urs WALDVOGEL, Felsberg (CH)

(72) Inventor: Urs WALDVOGEL, Felsberg (CH)

(21) Appl. No.: 18/424,160

(22) Filed: Jan. 26, 2024

Related U.S. Application Data
(63) Continuation-in-part of application No. PCT/EP2022/071200, filed on Jul. 28, 2022.

(30) Foreign Application Priority Data
Jul. 29, 2021 (CH) 070115/2021

(51) Int. Cl. G10D 3/153; G10D 1/08; G10D 3/12

(52) U.S. Cl. CPC G10D 3/153; G10D 1/085; G10D 3/12

(57) ABSTRACT

Disclosed is a tuning device (1) for stringed instruments (5) and a stringed instrument (5). The tuning device (1) comprises a limiting element (20) and a string clamping device (30). The limiting element (20) and the string clamping device (30) are pivotally mounted independently of one another, particularly on a common axis of rotation (40).

This application is a Continuation-in-Part of International application number PCT/EP2022/071200 filed Jul. 28, 2022, which claims priority to Swiss application serial number CH070115/2021 filed Jul. 29, 2021.

### FILED OF THE INVENTION

The present invention relates to a tuning device for a string instrument and to a string instrument comprising a tuning device according to the general terms of the respective patent claims.

### SUMMARY OF THE INVENTION

Various tuning devices are known from the state of the art. These are used on electric guitars, in particular. Colloquially, they are called tremolos, although this term is used incorrectly and a tremolo, i.e., a tuning device, is actually a vibrato. These devices make it possible to change the tension of the strings while playing the string instrument, resulting in a change in the pitch of the respective strings. In its original form, a vibrato is suspended, with the tension of the strings acting on the vibrato on the one hand and one or more springs counteracting the string tension on the other. The system is typically adjusted so that the vibrato is suspended and all the strings have a specific basic tuning. These vibratos are typically mounted on a knife edge, which also forms the pivot point. The vibrato can be pivoted around the knife edge so that the string tension is increased. An opposite movement is also possible, so the string tension is reduced.

This type of vibrato has several disadvantages. Several iterations are typically required to tune the string instrument. Changing the tension of a single string affects the entire vibrato and therefore also the tuning of the other strings. If a string breaks while playing, the string instrument is essentially unplayable as the strings lose their original tuning because the system is out of balance.

It is the task of the invention to eliminate at least one of the disadvantages of the prior art. In particular, a tuning device for a string instrument is to be provided that makes it possible to tune the string instrument without great effort and preferably prevents or at least reduces the iterative tuning of the strings. Preferably, the tuning device should be insensitive to the failures of individual strings.

This task is solved using the devices defined in the independent patent claims. Further advantageous embodiments result from the dependent patent claims.

The tuning device for a string instrument according to the invention comprises a limiting element and a string clamping device. The limiting element and the string clamping device are pivotally mounted independently of one another, particularly pivotally mounted on a common axis of rotation.

This allows the independent movement of the limiting element on the one hand and the string clamping device on the other.

However, the bearing on a common axis of rotation also enables the string clamping device and the limiting element to move together, whereby the relative displacement of the two elements in relation to each other can be prevented during this movement.

The string clamping device is in operative connection with the limiting element at a stop point. In other words, the string clamping device can be lifted off the limiting element in the first pivoting direction; independent pivoting or rotation in the opposite direction is prevented by the limiting element. In this direction, only joint pivoting of the string clamping device with the limiting element is possible.

This makes it possible to provide a fixed position for the string clamping device. Providing a fixed position makes it easy to tune the individual strings, since changing the tension of a single string has no effect on the other strings.

Of course, the strings are arranged on the string clamping device and exert a certain pre-tension on the device. The limiting element is arranged in such a way that it prevents the string clamping device from moving toward the strings, i.e., it acts against the pretensioning of the strings.

The position and direction are based on a standard arrangement. In this configuration, all strings are pretensions and arranged on the same side of the rotational axis. In this configuration, the pretension is reduced when the tuning device is pressed and increased when it is pulled or lifted. Pulling is accompanied by an increase in the angle in relation to the plane in which the strings are arranged, and pushing is accompanied by a reduction in the angle.

To disengage the string clamping device from the limiting device, it must be moved against the pre-tension of the strings. Therefore, the pre-tension force of the strings must be overcome to separate the string clamping device from the limiting element. This separation changes the length of the strings. Lengthening the strings results in increased tension, leading to a higher pitch. Conversely, shortening the strings reduces the tension, resulting in a lower pitch.

The tuning device can have a stop to limit the swivel movement of the limiting element.

The stop is functionally connected to the limiting element and holds it in a neutral position in one direction of the pivoting movement, preventing pivoting in that direction. However, movement in the opposite direction is possible. In other words, the limiting element can be lifted away from the stop in one pivoting direction, while movement in the opposite pivoting direction is prevented.

The limiting element can thus be held in a neutral position in one direction.

The stop is arranged in such a way that it prevents the limiting element from moving in the direction opposite to the string tension, i.e., it prevents an increase in the pre-tension of the strings.

Preferably, the limiting element is held in contact with the stop by a biasing element, particularly a spring.

The biasing element provides a force greater than the corresponding pretensioning force of the strings. The limiting element is thus securely held on the stop. However, if the force is increased toward the pretensioning force of the strings, for example, when the tuning device is pressed, the force of the biasing element can be exceeded and the limiting element can be lifted off the stop. This allows the pre-tension of the strings to be reduced, which results in a corresponding change in sound.

The biasing element can be attached to the tuning device or the string instrument using an adjusting screw. The pretension of the biasing element can be adjusted using an adjusting screw.

The biasing element can be attached to the limiting element using a fastening bolt. The fastening bolt is preferably adjustable transversely to the axis of rotation so that the suspension point of the biasing element on the limiting element can be adjusted in relation to the axis of rotation. With the same spring tension, different torques can be applied to the limiting element depending on the setting of the fastening bolt.

A tensioning element for adjusting the biasing element or for adjusting the string tension can be arranged on the limiting element. This makes it possible to adjust the tension of all strings simultaneously or to adjust the tensioning element.

The clamping element can have a fixed element and a movable element. The movable element is separated from the fixed element by an adjustable wedge. In the present case, fixed means that the fixed element is arranged in a fixed position on the limiting element, i.e., its relative position to the limiting element. The movable element can be moved relative to the fixed element.

To adjust the string tension, the stop is in operative connection with the movable element. Adjusting the adjusting screw changes the position of the limiting element and thus in the string tension.

To adjust the biasing element, the stop is in operative connection with the fixed element.

In both cases, the biasing element is attached to the movable element.

Thanks to the adjustable wedge, a specific position between the movable element and the fixed element can be set, allowing for the application of varying pre-tensions to the limiting element.

The string clamping device may include at least one clamping mechanism for securing a string, particularly at a variable distance from the pivot axis.

Securing the string at a distance variable to the pivot axis allows for assigning a specific change in the string's pre-tension to a particular pivot position of the string clamping device.

A specific pivot of the string clamping device, for example by 5°, results in a minor shortening or lengthening of the string near the pivot point, and a greater shortening or lengthening of the string further distanced from the pivot point.

A string instrument typically has several strings. A typical example of a string instrument is a guitar. Guitars typically have six strings, each with different elasticities. In other words, different forces must stretch or elongate the strings by the same amount. Stretching the highest sounding string by a certain amount of X results in a certain change in the sound, for example, the pitch of the note changes by a semitone. However, the same stretching of the lowest sounding string by the same amount X does not result in a change in the pitch of this string by a semitone, but in a different change, for example, by 3 to 4 semitones.

To change the pitch of the lowest sounding string by a semitone, this string must be stretched by a different amount.

The provision of clamping devices that can be arranged at different distances from the axis of rotation allows the String clamping device of the tuning device to assign an individual stretch to each string.

Therefore, it is possible to use the tuning device to adjust all the pitches of the strings of a string instrument with a single movement, for example by one semitone each.

This makes it possible to maintain a played chord by a certain distance when the tuning device is actuated. Tuning in the original position can therefore be transferred to another chord in a different position of the tuning device, which corresponds to a specific position of the tuning device. A single string, for example, can also be moved to the pivot point with this type of configuration so that it is not affected when the tuning device is operated. For example, a string that frequently breaks due to excessive overstretching can be excluded from tuning.

The strings on the tuning device can be adjusted so that, for example, the pitch of a first string is altered by a semitone while simultaneously changing the pitch of a second string by a whole tone.

In other words, a variety of combinations and different tunings can be achieved with this setup.

It goes without saying that the clamping mechanisms can be designed in such a way that the distance of the string from the pivot axis can also be negative. In other words, the string can be positioned on both sides of the pivot axis.

For instance, if all the clamping mechanisms are positioned on one side of the pivot axis, moving the string clamping device in one direction results in stretching each string, generally leading to an increase in the pitch of each respective note.

When a clamping mechanism is positioned on the opposite side of the pivot axis, the corresponding string is not stretched but shortened. Consequently, this string may undergo a change in pitch, for instance, by a semitone, but in this case, the pitch of this string is lowered by a semitone.

In such an arrangement, however, the pre-tension of this specific string acts against the pre-tension of the other strings.

The tuning device can feature a pretensioning system, which is attached to the string clamping device with an adjustable fastening bolt or an adjustable bracket, particularly a detent disc.

This creates an element that counteracts the pre-tension force of this specific string, ensuring that the tuning device remains in stable equilibrium. Thus, the respective components, such as the limiting element and the string clamping device, along with their counterparts, namely the stop and the stop point, are reliably kept in contact.

This pretensioning system may include multiple springs.

It may be provided that this pretensioning device is attached to a fastening bolt on the string clamping device. The fastening bolt is preferably adjustable so that the fastening point of the pretensioning device can be adjusted in relation to the axis of rotation. With the same spring tension, different torques can be applied to the string clamping device depending on the setting of the fastening bolt. In particular, the fixing point can be adjusted such that it can be positioned on either side of the axis of rotation. In this way, the string tension can be increased or decreased as required.

If the fixing point is arranged on the axis of rotation, the effect of the pretensioning device can also be bridged.

It is conceivable that the pretensioning system includes multiple springs acting on different sides of the axis of rotation. For this purpose, the fastening bolt can be designed to protrude on both sides of the axis of rotation, allowing, for example, two springs to each engage at one end of the fastening bolt. The adjustability of the fastening bolt allows for the simultaneous adjustment of the springs' attachment points in relation to the axis of rotation.

A corresponding arrangement can also be provided for the preload element if, for example, it is provided by several springs or has an additional preload element.

In all versions, the fastening bolt is preferably arranged such that the respective fastening points are opposite each other in relation to the axis of rotation.

Instead of a fastening bolt, it can also be arranged to attach the springs to a bracket that is adjustable in relation to the string clamping device. This bracket can be locked in position relative to the string clamping device, allowing them to move together. The points of force application of the springs are located on the circumference of the bracket. Depending on the position of the bracket relative to the string clamping device, the forces acting on the string clamping device vary. To enhance the effect, the bracket can also be positioned eccentrically to the axis of rotation.

The bracket can be designed as a two-part locking disk. One half of the locking disk is rigidly connected to the string clamping device, and the second half can have corresponding fastening elements as points of application for the springs.

The two parts of the locking disk can be pressed together by a pre-tensioned spring so that they can only rotate in relation to each other when a certain force is applied. The part of the locking disk with the points of application for the springs can be adjusted accordingly, for example, with a lever tool, so that the spring force of the pretensioning device on the string clamping device changes.

A suitable bracket can also be provided for the biasing element and/or for additional springs, which, for example, may act solely on the limiting element.

Therefore, the biasing element can be attached to the limiting element with an adjustable bracket, whereby the adjustable bracket is designed, in particular, as a locking disk.

The console can also be used with just one point of attack.

The clamping device can, for example, be designed as a series of openings located at different distances from the axis of rotation, particularly on both sides.

In other words, the string clamping device can be designed in the form of a perforated plate, with a specific arrangement of openings provided for each string to be clamped, each forming a clamping mechanism for securing the respective string.

This allows the strings to be clamped in designated positions that enable specific, predefined lengthening or shortening of the respective strings.

Alternatively, the string clamping device can feature a long slot. This long slot particularly extends beyond the axis of rotation and on both sides of it. The clamping mechanism includes a saddle-shaped seat for accommodating the end of a string, which is arranged to be movable along the long slot.

This makes it possible to continuously adjust and move the respective suspension point of a string relative to the axis of rotation. The pitch of the respective strings can be very finely adjusted.

The saddle-shaped seat for holding the end of the string can be designed such that a plug-in axle can be inserted into it, which can be pushed through an eyelet at the end of the string. Preferably, the quick-release axle and the saddle-shaped seat are designed as a snap connection.

This makes it quick and easy to insert and/or change a string.

It may be provided that an adjusting screw is arranged on the tensioning device or on the string clamping device with which the saddle-shaped seat can be moved along the slotted hole.

The clamping device, i.e., the saddle-shaped seat, can be precisely adjusted using an adjusting screw. It is also secured against accidental adjustment.

It can be arranged that the saddle-shaped seat is positioned in a corresponding groove of the string clamping device and can slide within it.

Precise guidance and adjustment are possible.

Additionally, it can be arranged that the adjusting screw is mounted in or on a base which is adjustably positioned in relation to the axis of rotation, particularly within the groove.

This enables quick rough adjustment of the clamping device.

Clamping elements such as a screw can be provided to fix the base in place.

Alternatively, the adjusting screw can be permanently mounted on the string clamping device and the saddle-shaped seat can be moved along the longitudinal axis with the thread of the adjusting screw.

The saddle-shaped seat can feature multiple positions for accommodating a corresponding plug axle.

Additionally, or alternatively, it can be arranged that the limiting element includes at least one deflection device for redirecting a string, particularly at a distance variable to the axis of rotation.

This design allows for the space-efficient integration of the tuning device, particularly within the existing body of a string instrument. The variable distance of the deflection device, as previously described for the clamping mechanism, enables the assignment of an individual stretch to each string for a specific rotational movement of the string clamping device within the tuning device. Therefore, it is possible to adjust the pitch of all the strings of a string instrument by a semitone, for example, with a single movement of the tuning device.

For further advantages and technical details of the deflection device, please refer to the corresponding description in relation to the clamping device. These apply analogously.

The deflection device can have an elongated hole, whereby this elongated hole extends, in particular, over the axis of rotation and on both sides. The deflection device has a deflection roller that is displaceable along the slot.

This enables continuous adjustment and shifting of the respective deflection points of a string relative to the rotational axis. The pitch of the respective strings can be very finely adjusted.

The deflection roller can be arranged on an axle, which in turn is arranged on a carriage. The carriage is slidably mounted in the slotted hole so that its distance can be adjusted in relation to the rotational axis.

This design allows safe, stable, and precise guidance of the deflection pulley and therefore precise adjustment of the deflection device.

It can be arranged that the deflection pulley along the long slot is movable with an adjusting screw. The adjusting screw is functionally connected to the carriage, allowing it to be moved via the adjusting screw.

Alternatively, it is also possible to dispense with the adjusting screw and simply clamp the slide in the slotted hole with a screw that passes through the slotted hole. This type of clamping is analogous to the clamping of the base of the clamping device, as described above.

In this case, the strings can be arranged on the string clamping device without the possibility of adjustment because the adjustment can be performed via the deflection device.

A saddle-shaped seat can also be used for fastening, as described for the clamping device.

In the version with a deflection device, there may be settings in which the strings exert only a slight tension. A pretensioning device of the tuning device can be provided to support and/or ensure the return of the string clamping device to its original position, particularly the center position.

The pretensioning system can be designed as a compression spring or a coil spring, positioned between the limiting element or a body of the string instrument, or a mounting frame of the tuning device, and the string clamping device.

Alternatively, the pretensioning device could be designed as a torsion spring.

In the case where the strings are arranged at the string clamping device without adjustment possibility, since the adjustment can be made via the deflection device, a simplified form of the tuning device can also be provided.

In this alternative embodiment, the string clamping device can be an integral part of the limiting element; in other words, the limiting element and the string clamping device are formed as one piece and are not independently pivotable. This combined element is subsequently referred to as a block.

The deflection device features a pulley, which is arranged adjustable in relation to the rotational axis of the tuning device and perpendicular to this axis.

The strings are clamped directly at the block, preferably at an end distanced from the rotational axis. The string clamping device is thereby reduced to a clamping mechanism.

This results in the following configuration. The tuning device includes a block. The block is pivotally mounted around and particularly on a rotational axis and features a deflection device to redirect a string, especially a deflection device with a pulley. The deflection device is arranged adjustable in relation to the rotational axis of the tuning device and perpendicular to this axis.

A clamping mechanism is arranged on the block.

The clamping mechanism for clamping the strings is preferably positioned opposite the deflection device, that is, on a side opposite in relation to the rotational axis.

By arranging an adjustable deflection device at the limiting element, and thus as described here at the block, each string can be individually adjusted and a very high tuning stability can also be achieved. The strings are stretched over their entire length when tuning, including between the clamping mechanism and the deflection device. Since the deflection device features a pulley, the string can stretch or contract essentially friction-free along its entire length and also return to its original position. This ensures that after operating the tuning device, the strings regain their original tuning. This is not the case with friction-based systems.

To limit the pivoting movement of the block, the tuning device can have a stop. The stop is operatively connected with the block and holds it in a first direction of the pivoting movement in a neutral position and prevents pivoting in this direction. However, movement in the opposite direction is possible. In other words, the block can be lifted from the stop in a first pivoting direction and movement in the opposite pivoting direction is prevented.

The block can thus be held in a neutral position in one direction.

The stop is arranged to prevent movement of the block in the direction opposite the string tension, thus preventing an increase in the pretensioning of the strings.

Preferably, the block is held in contact with the stop by a biasing element, particularly a spring.

The biasing element provides a force greater than a corresponding pretensioning force of the strings. The block is thereby securely held on the stop. However, if the force towards the pretensioning force of the strings is increased, such as by pressing the tuning device, the force of the biasing element can be exceeded and lifting the block from the stop is enabled. This allows for a reduction in the pretensioning of the strings, resulting in a corresponding change in sound.

It should be noted that with this configuration of block and stop, tuning in only one direction is possible. However, this is sufficient in many cases.

This configuration allows, as already described, for tuning the string instrument without performing a multitude of iterations. The increase or decrease in tension of a single string does not affect the tuning of the other strings.

This configuration is particularly advantageous in connection with a bridge that features a pulley for each string. A corresponding bridge is further described below.

There is also the possibility to use the present configuration without a stop, to allow tuning in both directions. The advantages of tuning stability are also retained in such a freely floating configuration.

To pivot the limiting element and/or the string clamping device, or the block, an actuating lever can be arranged on the tuning device.

The tuning device can be actuated as required using an actuating lever. An actuating lever also enables the tuning device to be actuated from outside the housing, for example. A relatively high torque can also be applied with relatively little force via an actuating lever, provided that the actuating lever has appropriate lever ratios.

It may be provided that the actuating lever is connected to the string clamping device via a pull rod.

By providing a pull rod, the actuating lever can also be arranged at a distance from the tuning device. This is particularly advantageous if, for example, the tuning device has to be accommodated inside the string instrument, for example, inside the body of a string instrument. Depending on the design of the string instrument, it may be necessary to place the tuning device relatively far from the location where the strings are manually played. To shorten the reach of the playing hand, it is particularly envisaged to position the actuation lever close to the natural position of, for example, the playing hand. Connecting the actuation lever via a pull rod is advantageous especially in these layouts.

Preferably, the actuation lever is arranged in a holding element and, in particular, its height relative to the holding element is adjustable.

Therefore, the operating lever can be arranged in different positions relative to the holding element. This allows, for example, individual adjustment of the operating lever for the respective players of the string instrument.

Additionally, or alternatively, such adjustability allows for positioning the actuation lever relative to the holding element in a way that at least one of its components, depending on its placement, protrudes to varying extents from the holding element. Depending on the setting of the actuation lever, this enables interaction with a corresponding counterpart, such as a stop.

At least one stop can be arranged on the tuning device, which is or can be functionally connected to the actuation lever. This stop can limit the movement of the actuation lever particularly depending on the adjusted height of the actuation lever.

It may be provided that the actuating lever is not in contact with the stop at a first set height or cannot be brought into contact with the stop, so that the tuning device can be actuated in both directions.

At a second set height, the stop can be designed in such a way that the movement of the actuating lever is restricted in the first direction, for example, when it is pressed. This makes it possible to always achieve the same tuning when moving the actuating lever up to this stop.

Also, at a second or another adjusted height, it can be arranged that the movement of the actuation lever in its second direction is limited, such as when pulling.

Consequently, moving the actuation lever up to this stop can always achieve precisely the same tuning.

It may be provided that at a further set height, the actuation of the actuating lever is restricted in both its first and second directions.

The respective stop may be adjustable with an adjusting screw, which makes it possible to vary the pitch change.

At another adjusted height, it can be arranged that the actuation lever is completely fixed and cannot be moved in either of the two possible directions. It may be arranged that this fixation is identical to the neutral position of the tuning device. However, it is also conceivable that this fixation is identical to the stop concerning the second adjusted height or another adjusted height, so that with the appropriate setting of the strings, they are fixed in an unchangeable tuning of the string instrument.

This makes it possible, for example, to transpose the basic tuning of the instrument up or down.

It can be provided that it has circumferential grooves into which, for example, a ball catch can engage for fixing the respective height of the actuation lever.

The tuning device can have a bridge to support the strings. This makes it possible to provide a tuning device that provides all elements together in a single device from the point of contact of the string at the end of its vibrating length. This makes it possible to provide a system with precisely matched components.

The bridge can feature a deflection pulley for each string, providing a contact point for the respective string. The deflection pulley is adjustable along the longitudinal extension of the string. To adjust the deflection pulley, an adjusting screw may be provided, which acts against the tension of the string.

This allows for the precise adjustment of the string's vibrating length, thereby ensuring the accurate intonation of the frets.

The adjusting screw is arranged such that it is under pressure.

This allows additional space to be created in the area between the deflection pulley and the tuning device.

The adjusting screw preferably has a spherical head, which is spherically mounted in the bridge.

Therefore, the screw can be rotated around its longitudinal axis, allowing the deflection pulley to be moved. On the other hand, this type of mounting ensures that the adjusting screw is immovable in all directions, thus providing a fixed holding point.

The deflection pulley can be arranged in a holder in which the adjusting screw is engaged.

This holder is preferably adjustable in height, which in generic use means its distance, for example, from the guitar body, can be varied. Two adjustable elements, particularly set screws, can be provided for this purpose.

Alternatively, it is conceivable to forego the adjusting screw and provide three or more, particularly four, adjustable elements to maintain the holder at the correct height. To fix the holder and thus the deflection pulley in place, a detachable connection to the bridge can be arranged, preferably a screw that engages from below through the bridge into the holder.

This bridge configuration is particularly advantageous with a version of the string clamping device featuring a block, as described above.

A further aspect of the invention relates to a string instrument, particularly a guitar, comprising a tuning device as described here.

All components of the string instrument can be matched to each other and adjusted accordingly so that the instrument has an individual and precise configuration.

Additionally, it is possible to equip the string instrument with fine tuners. In this case, it would be possible to secure the strings in the area of the nut, i.e., at the transition to the headstock. The fixation occurs between the nut and the tuning pegs. A fine tuner can be positioned between the fixation and the nut, as known, for example, from US Patent 2014/0260890 A1.

Alternatively, it would be possible to fix the strings directly to the saddle and provide fine-tuning elements on the string clamping device. In particular, it would be possible, for example, to arrange the string ends on an element that is adjustable toward the string, such as a sleeve. This could be adjustable in height using a fine thread so that the tension of the string can be easily increased or decreased.

The tuning device can have deflection rollers, which are designed as adjustable rollers, in particular.

By providing deflection pulleys, the strings can be individually inserted into a string instrument housing and/or guided within this housing.

It would also be conceivable to design the deflection rollers as adjustable rollers. In this case, they are preferably arranged between a bridge on which the strings rest and the string clamping device. In this form, they form additional tensioning elements with which the string tension can be adjusted. This arrangement also enables fine tuning.

Additionally, a “Dropped-D” function could be provided by means of a comparable element, such as an adjustable roller between the bridge and the string clamping device, which acts on a single string. This roller could, for example, be brought into an active position and back again by pressing a button or flipping a lever. A latching pressure switch, for instance, is suitable for this purpose. The active position, for example, involves an adjustment to a specific pitch.

Both the Dropped D function and the fine tuners are compatible with all the design examples.

All rotationally movable elements, such as deflection rollers, string clamping devices, and limiting elements, can be supported by ball bearings. Ceramic ball bearings, in particular, can be used because they have extremely low friction coefficients and are maintenance-free.

### BRIEF DESCRIPTION OF THE DRAWINGS

The invention is explained below with the aid of schematic drawings and figures. It shows:

FIG. 1: A string instrument;

FIG. 2A: A schematic representation of the tuning device in the neutral position;

FIG. 2B: A schematic representation of the tuning device shown in FIG. 2A in a drawn position;

FIG. 2C: A schematic representation of the tuning device shown in FIG. 2A in the depressed position;

FIG. 3: A perspective view of the tuning direction in a body;

FIG. 4: A perspective view of the tuning device, as shown in FIG. 3;

FIG. 5: A sectional view through the arrangement shown in FIG. 3;

FIG. 6: An orthogonal sectional view of the tuning device, as shown in FIG. 4;

FIG. 7: An orthogonal sectional view of the tuning device, as shown in FIG. 4;

FIG. 8: A sectional view through the tuning device, as shown in FIG. 4;

FIG. 9: A sectional view through the tuning device, as shown in FIG. 4;

FIG. 10: A sectional view through the tuning device, as shown in FIG. 4;

FIG. 11: A perspective view of the tuning device direction;

FIG. 12: The view according to FIG. 11 in a sectional view;

FIG. 13: A sectional view of the tuning device as shown in FIG. 11.

FIG. 14: A sectional view of the tuning device as shown in FIG. 11.

FIG. 15: A sectional view of the tuning device as shown in FIG. 11.

FIG. 16: A detailed view from FIG. 15;

FIG. 17: a side view of FIG. 15;

FIG. 18: A perspective view of the tuning device;

FIG. 19: The view according to FIG. 18 in a sectional view;

FIG. 20: A sectional view of the tuning device as shown in FIG. 18.

FIG. 21: An orthogonal sectional view through the tuning device, according to FIG. 18;

FIG. 22: A detailed view of the clamping device;

FIG. 23: The tuning device according to FIG. 18 in an alternative design with fine tuners;

FIG. 24: A detailed sectional view of the tuning device according to FIG. 4;

FIG. 25: A detailed view of an alternative design of the tuning device is shown in FIG. 20.

FIG. 26: A sectioned perspective view of the bridge

FIG. 27: A detailed view of the clamping device;

FIG. 28: A perspective view of an alternative bridge, as shown in section.

FIG. 29: An alternative embodiment of a tuning device.

### DETAILED DESCRIPTION OF THE PREFERRED EMBODIMENTS

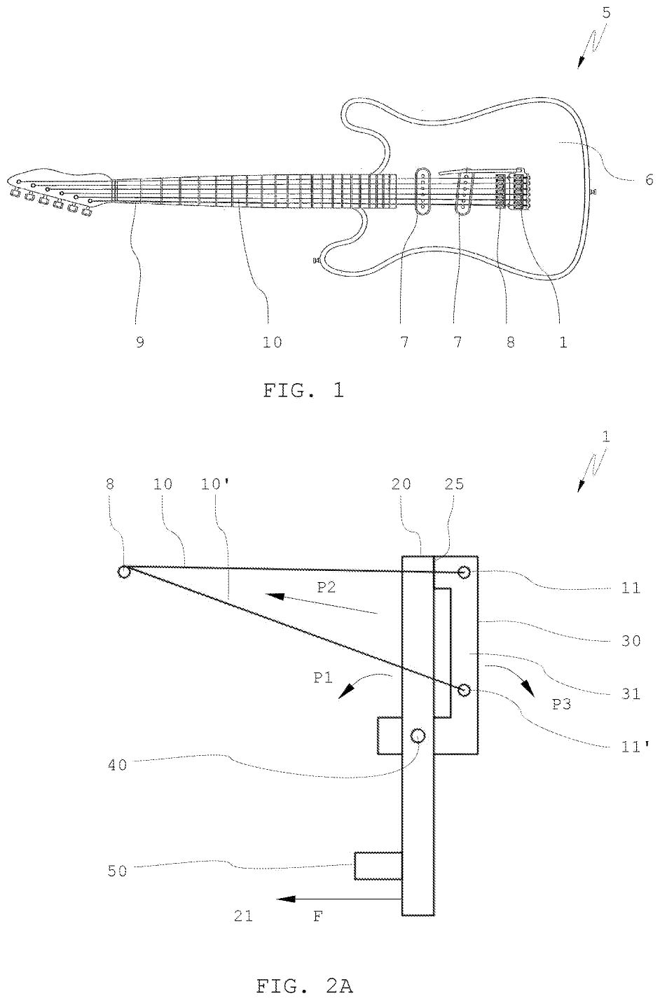

FIG. 1 shows the string instrument 5. The string instrument 5 comprises a body 6 and a neck 9 arranged thereon. Neck 9 comprises an unspecified headstock on which strings 10 are clamped. The strings 10 extend along the neck 9 toward the tuning device 1. The strings 10 cross pickups 7 and rest on a bridge 8 in front of the tuning device 1. The tuning device 1 is essentially arranged inside body 6. The string instrument 5 is designed as an electric guitar. A saddle on which strings 10 also rest is arranged d at the transition to the head. Therefore, the strings 10 have a specific vibration length between the saddle and bridge 8. The basic tuning of the strings 10 or the string instrument 5 is set by pegs on the headstock. To set the specific vibration length, it is possible to adjust the contact points of strings 10 on bridge 8 in relation to the nut. Typically, they are suspended from tension-loaded screws.

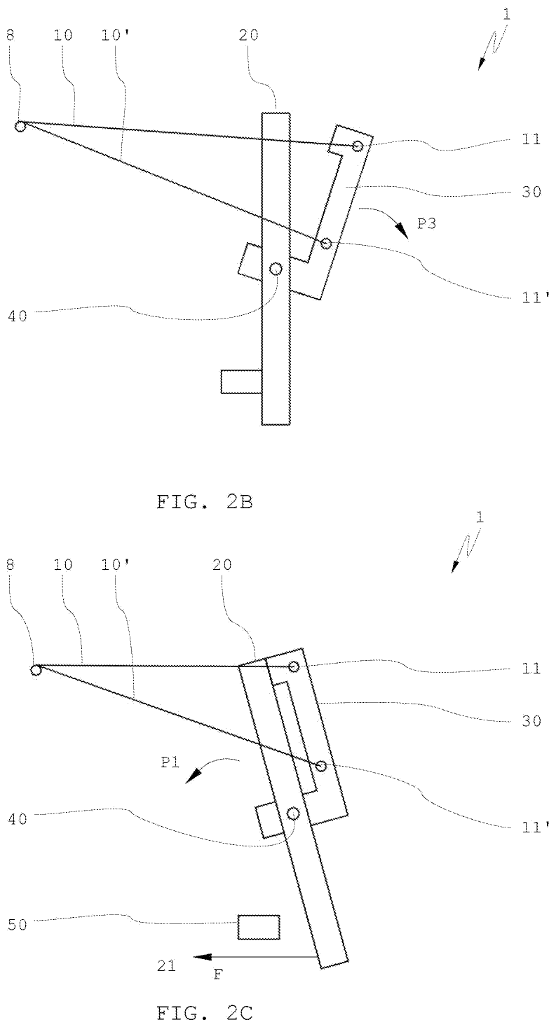

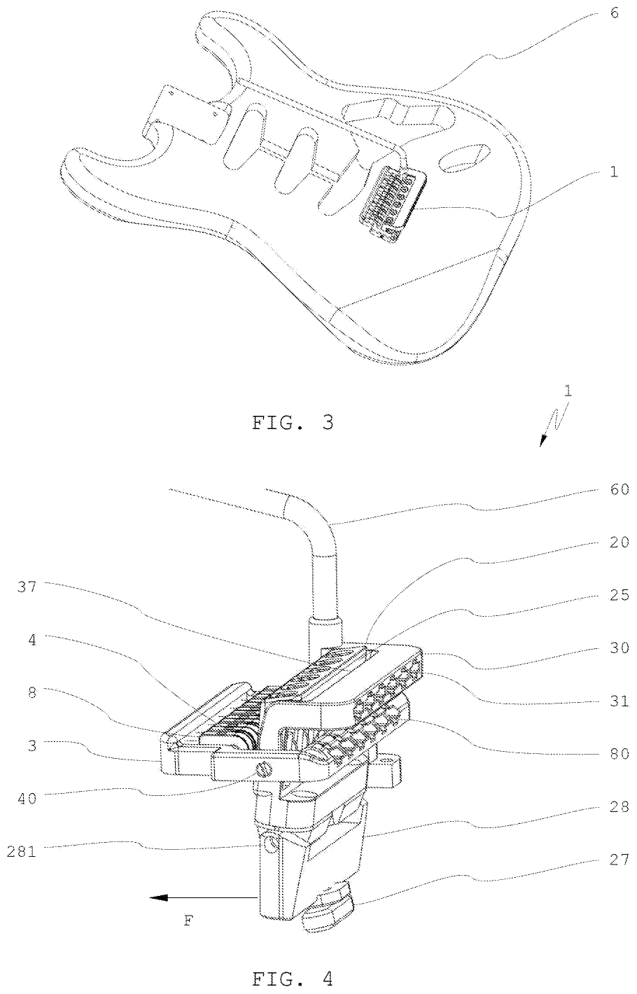

FIG. 2A shows a schematic representation of a tuning device 1 in the neutral position. The tuning device comprises a limiting element 20 and a string clamping device 30. The limiting element 20 and the string clamping device 30 are mounted on the common axis of rotation 40. The limiting element 20 rests on stop 50. As can be seen from FIG. 2A, the limiting element 20 can only move in the direction of the arrow P1. In other words, it can only be pivoted toward the arrow P1.

To hold the limiting element 20 in the position shown here and in contact with stop 50, it is pulled toward stop 50 by a biasing element 21. The biasing element 21 is illustrated here by the force vector F.

At the string clamping device 30, a clamping mechanism 31 is arranged, which is not further illustrated in this representation. Exemplified here are a first string 10 and a second string 10′. Both strings 10 and 10′ rest on the bridge 8. By means of the clamping mechanism 31, a first end 11 of the first string 10 and a second end 11′ of the second string 10′ are held at a specific distance from the axis of rotation 40 on the string clamping device 30. The distance between the first string end 11 and the pivot point 40 is greater than the distance between the second string end 11′ and the pivot point 40.

The string clamping device 30 rests with one end on a stop point 25 of the limiting element 20. Consequently, the string clamping device 30 can only be moved in direction P3 around the pivot axis 40, as it rests against the limiting element 20 in the opposite direction, which prevents rotation in that direction, unless the force F of the biasing element 21 is overcome.

The strings 10 and 10′, as well as other possible strings not shown here, exert a pre-tension force on the tuning device 1, which collectively acts in the direction of arrow P2. The force F, applied by the biasing element 21, results in a torque around the pivot axis 40, which is greater than the torque caused by the pre-tension force of the strings 10. Accordingly, the tuning device 1 remains in the position shown in FIG. 2A.

FIG. 2B illustrates a schematic representation of the tuning device from FIG. 2A in a pulled position. The string clamping device 30 has been pivoted in the direction of arrow P3. To achieve this, a force was applied to the string clamping device 30, moving it against the pre-tension force of the strings 10, thus pivoting it around the pivot axis 40.

Compared to FIG. 2A, it is evident that the distance between the bridge 8 and the string end 11 has increased. As a result, the string 10 has been stretched, thereby increasing its pre-tension.

The distance between bridge 8 and the second string end 11′ has also been increased compared with the illustration in FIG. 2A. The second string 10′ has therefore also been stretched, thus increasing its pre-tension.

Since the attachment of the second string end 11′ is closer to the pivot axis 40, the stretching or lengthening of the second string 10′ is less than the elongation of the first string 10. With identical strings, the second string 10′ would thus experience a different change in pitch than the first string 10. However, in this case, the strings 10 and 10′ have different characteristics, so that in the position shown here, the pitch of both has changed by one semitone each. Depending on the distance of the respective string ends 11 and 11′ from the pivot axis 40, different combinations of (harmonic) string relations can be preset.

FIG. 2C shows a schematic representation of the tuning device 1 in a pressed position. The string clamping device 30 has been moved in the direction of arrow P1. To achieve this, a force was applied to the string clamping device 30, moving it together with the limiting element 20 against the spring force F of the biasing element 21, thus pivoting it around the pivot axis 40.

Compared to FIG. 2A, it is evident that the distance between the bridge 8 and the string end 11 has decreased. Consequently, the string 10 has been shortened, thereby reducing its pre-tension.

The distance between bridge 8 and the second string end 11′ is also shortened compared to the illustration in FIG. 2A. The second string 10′ has therefore also been shortened, thus reducing its pre-tension.

Since the attachment point of the second string end 11′ is closer to the pivot axis 40, the shortening of the second string 10′ is less pronounced than the shortening of the first string 10. If the strings were identical, the second string 10′ would thus experience a different pitch change than the first string 10. However, in this case, strings 10 and 10′ have different properties, so that in the position shown here, the pitch of both strings has changed by a semitone each. Depending on the distance of the respective string ends 11 and 11′ from the pivot axis 40, different combinations of (harmonic) string relations can thus be preset.

In principle, it is also conceivable to arrange the string ends 11 and 11′ in relation to the pivot axis 40 on the string clamping device 30 such that the first string end 11 is positioned on one side of the pivot axis 40 and the second string end 11′ on the other side. In other words, a swiveling movement of the string clamping device 30 results in shortening the length of one string 10 and lengthening the other string 10′, or vice versa, leading to corresponding changes in their pitches. However, this schematic representation does not show the actual extension of the string clamping device.

FIG. 3 presents a perspective view of a tuning device 1 integrated into the body 6 of a guitar. In this instance, the tuning device 1 is designed to be installed in existing guitars with suitable bodies 6, without necessitating changes to the body 6, except perhaps for the addition of screws into areas of the body 6 that are concealed by originally mounted devices.

This particular embodiment of the tuning device 1 allows for upgrading existing guitars.

As can be seen in FIG. 3, part of tuning device 1 is arranged outside body 6 so that the paths required to tune the strings can be traveled.

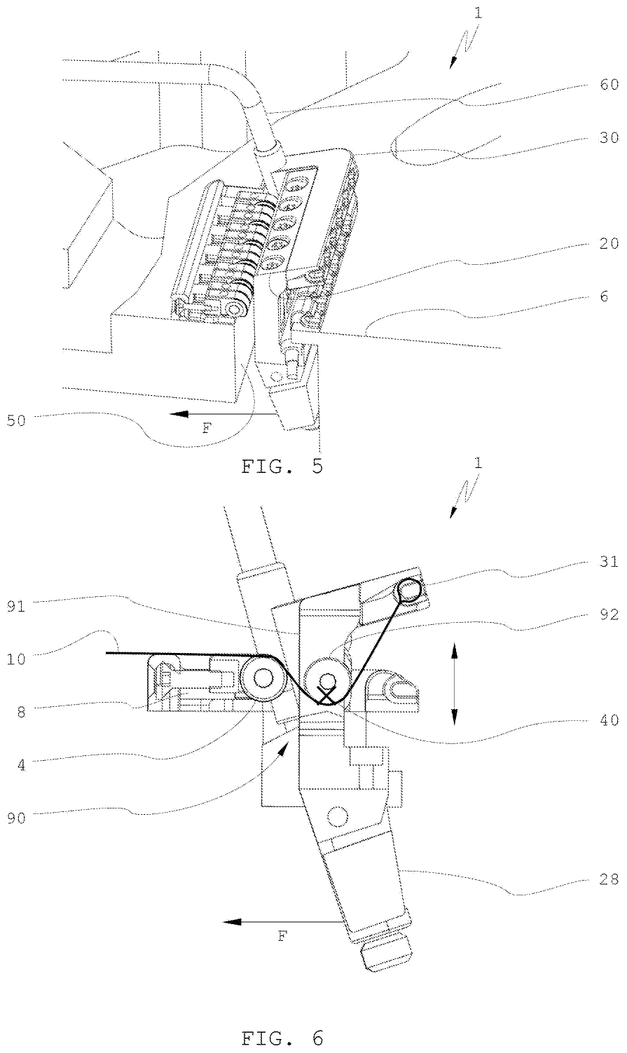

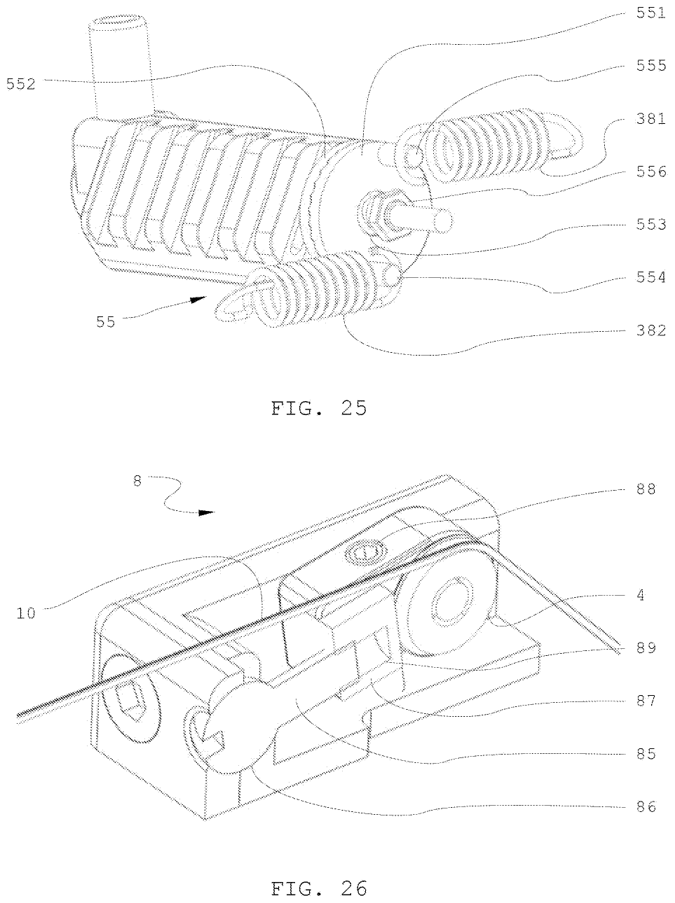

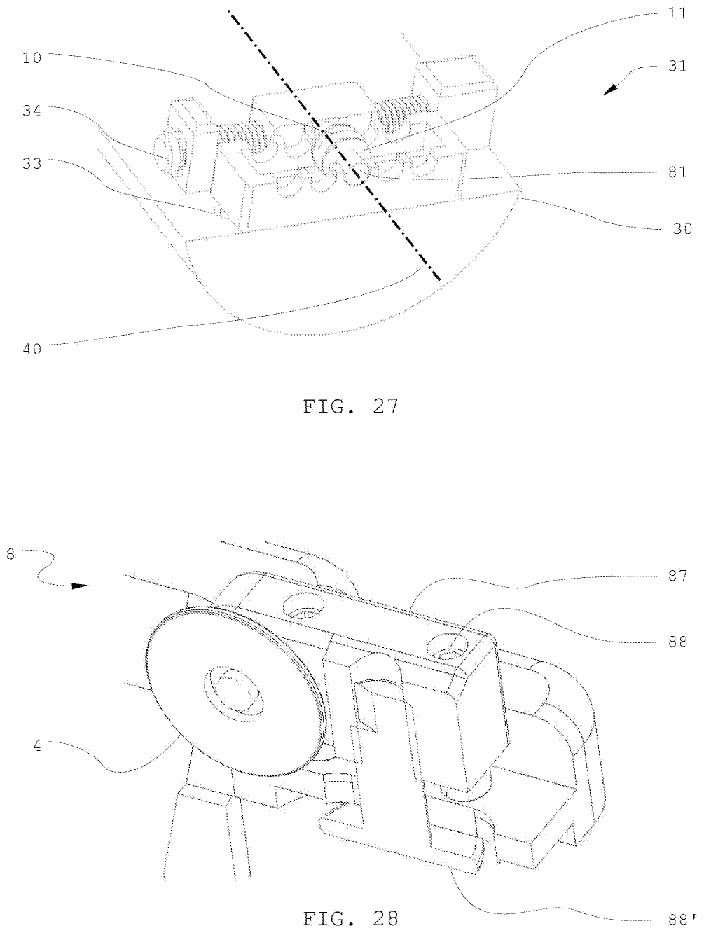

FIG. 4 illustrates a perspective view of the tuning device, as seen in FIG. 3. This device features a limit element and a string clamping device, both pivotally mounted around a common axis. The axis is situated on a mounting frame which also provides a bridge, where the strings, not shown here for simplicity, are positioned. Each string is associated with a moveable pulley on the bridge. These pulleys allow for the individual adjustment of the vibrating length of each string. The specific design of these pulleys is depicted in FIG. 26.

Several clamping mechanisms are arranged on the string clamping device, with only one of these mechanisms marked with a reference numeral for illustration purposes.

A clamping element 28 is arranged on the limiting element 20, which is pivotally mounted on the limiting element 20 with the axis of rotation 281. Shown by the arrow F is a biasing element, which is not described or shown here in more detail and is connected to the tensioning element 28. The clamping element 28 is pulled in the direction of the arrow F by the force of this biasing element. The clamping element 28 rests with a stop on the limiting element 20. Accordingly, the limiting element 20 is pivoted about the rotation 40 axis. This swivel movement is limited by a stop not shown here.

A corresponding stop 50 is shown in FIG. 5. In this case, the stop 50 is provided by the body 6 of the string instrument. It can be envisaged to attach a damping element to this stop, so that the contacts between the elements are less harsh.

FIG. 4 shows actuating an lever 60, which is functionally connected to the string clamping device 30. In the depiction according to FIG. 4, the actuating lever 60 is operated and pulled. The string clamping device 30, in the depiction according to FIG. 4, is spaced apart from the limit element 20 and pivoted against a preload force resulting from the tension of the strings. In the rest position, the string clamping device 30 rests on the limit element 20 at the stop point 25. The stop point 25 is designed as a surface of the limit element 20. A corresponding stop point 37 on the string clamping device 30 is also designed as a surface of the string clamping device 30.

The string clamping device 30 is mounted on both sides of the pivot axis 40 and embraces the limiting device 20 on two sides, each with a leg. The stop points of the string clamping device, which are designed as surfaces in this case, are located between the legs.

In contrast, FIG. 5 shows a representation of the tuning device 1 in which the actuating lever 60 is pressed. The angle between the plane of the strings and the string clamping device 30 is reduced here compared with the representation in FIG. 4. The limiting element 20 is pivoted together with the string clamping device 30 and moved against the force F of the biasing element.

FIG. 6 shows an orthogonal sectional view through the tuning device 1 according to the representation in FIG. 5. In FIG. 6, the course of a string 10 is shown as an example. The string 10 is guided over the pulley 4 of the bridge 8 and under the pulley 92 of a redirection device 90. The end of the string 10 is attached to the clamping device 31 of the string clamping device 30.

The deflection pulley 92 can be moved toward the double arrow in slotted hole 91 and its distance from the axis of rotation 40 can therefore be adjusted.

The tuning device 1 is actuated in the representation according to FIG. 6, in particular, pressed down. By pressing the detuning device 1, the distance between the redirecting pulley 92 and the pulley 4 of the bridge 8 changes. This reduces the tension in the string 10 and a note played on this string 10 becomes lower.

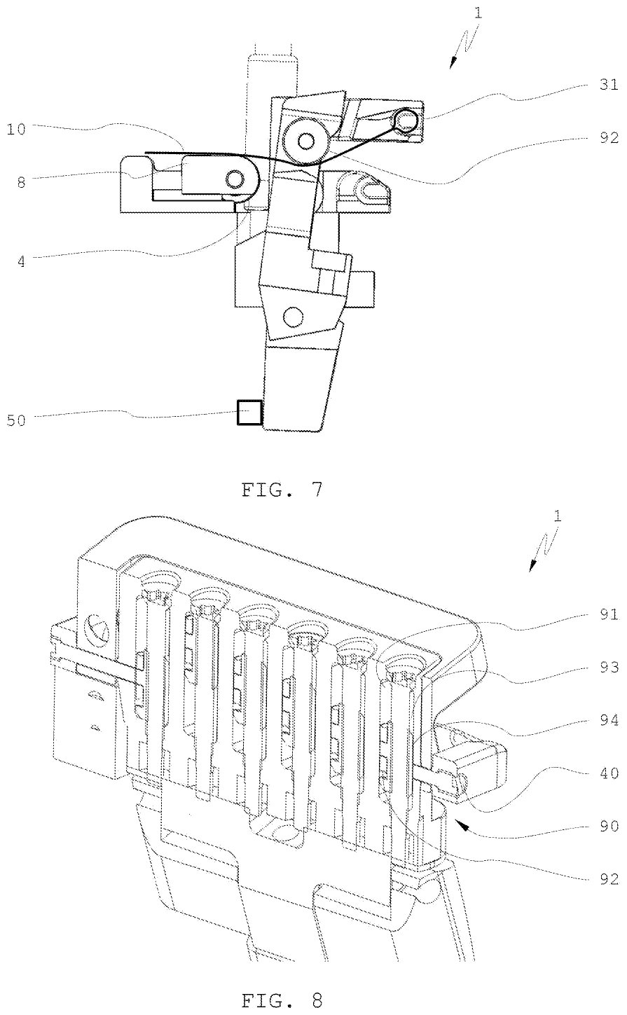

FIG. 7 shows an orthogonal sectional view through the tuning device 1 according to the depiction in FIG. 4. The course of the string 10 is similar to that in FIG. 6, but with a greater distance of the redirecting pulley 92 from the pivot axis 40. For details regarding the individual elements, reference is made to FIG. 6.

In the illustration shown in FIG. 7, the tuning device 1 is actuated and, in particular, pulled. Pulling the tuning device 1 does not change the distance between deflection pulley 92 and deflection pulley 4 of bridge 8, but it does change the distance between deflection pulley 92 and tensioning device 31. This increases the tension in the string 10, and a note struck with this string 10 is raised.

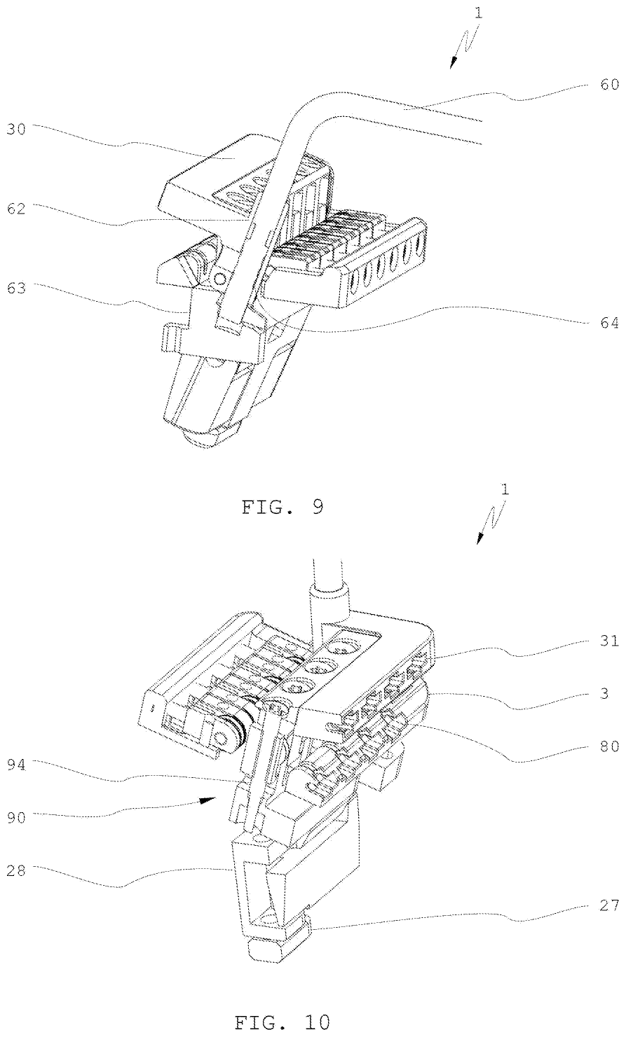

FIG. 8 shows a sectional view through the tuning device 1 according to FIG. 5 along, or rather through, deflection devices 90. For simplicity, only one of the deflection devices 90 is provided with reference signs. The deflection device 90 has an elongated hole 91 in which a slide 94 is arranged. A deflection roller 92 is arranged on slide 94.

The carriage 94 can be moved relative to the axis of rotation 40 together with the guide pulley 92 using the adjusting screw 93.

The elongated slot 91 extends with respect to the pivot axis 40 beyond the pivot axis 40, meaning it spans both sides of the pivot axis 40. The carriage 94 with the redirecting pulley 92 can thus be moved to either side of the pivot axis 40, resulting in varying changes in pitch when the tuning device 1 is operated. FIG. 8 clearly shows that each of the six depicted redirecting devices 90 is positioned differently.

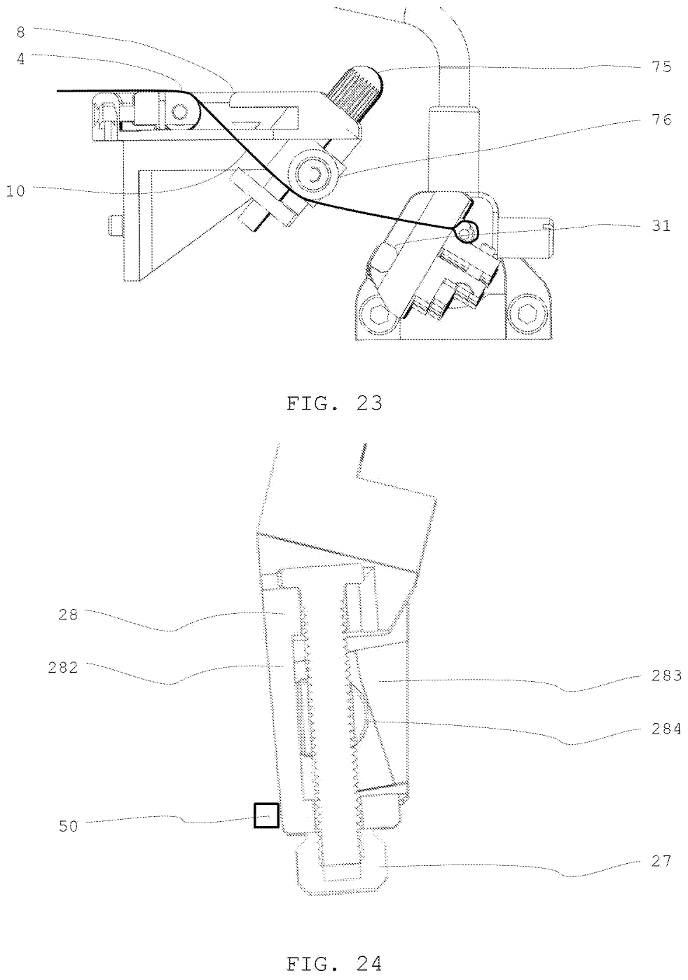

The deflection device 90 can also be fastened in the same way as shown in FIG. 22. In other words, the adjusting screw could be dispensed with and only one screw could be provided, which engages through the limiting element 20 and thus fixes the deflection device.

FIG. 9 shows a sectional view through the tuning device 1, as shown in FIG. 5. The section extends through the actuating lever 60. Several specific elements are now visible on the actuating lever 60. The actuating lever 60 is mounted in the retaining element 62 of the string clamping device 30. The retaining element 62 is designed as a bore in this case.

The actuating lever 60 features several circumferential notches. A ball catch, not shown in detail, positioned in a bore perpendicular to the holding element 62, engages with these notches 64, securing the actuating lever in a specific position.

In this instance, three notches 64 are displayed, and the actuating lever 60 can thus be locked at three different heights. Also visible in FIG. 9 is a stop 63 into which the actuating lever 60 engages. Depending on the height setting of the actuating lever 60, it engages more or less deeply into the stop 63. The stop 63 is designed in such a way that it limits the movement of the actuating lever 60 at different engagement depths. This arrangement allows positioning the actuating lever 62 in predefined positions that are consistently reproducible. In these positions, the redirecting pulley 92 of the redirecting devices 90 can be set for predefined tunings of the respective strings 10.

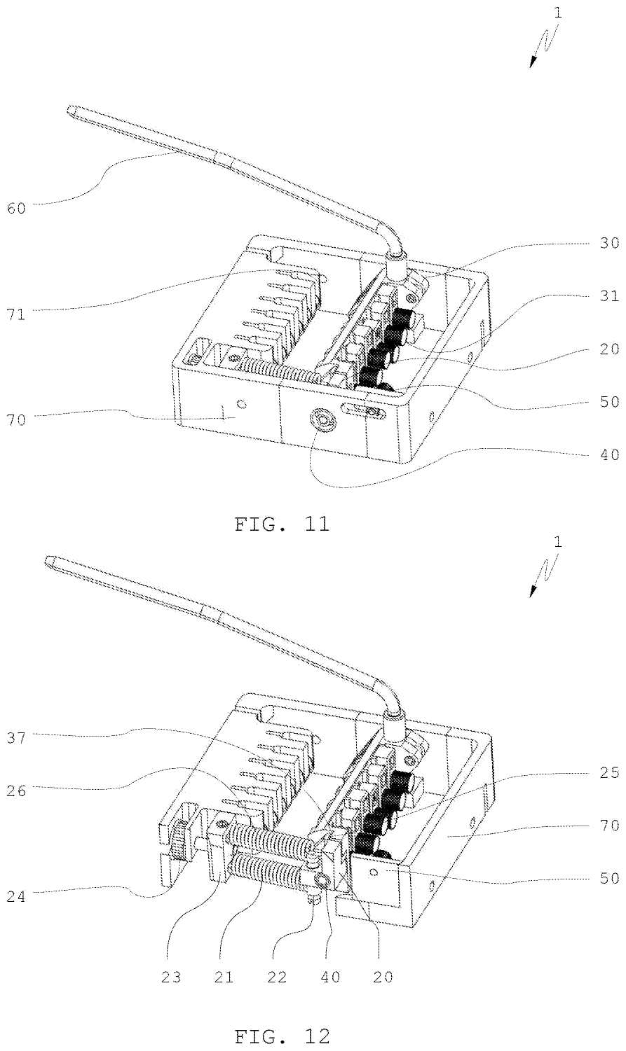

FIG. 10 presents a sectional view of the tuning device 1, as depicted in FIG. 9 but from a different, rotated perspective. This cut extends through the set screw of the redirecting device 90. In this illustration, it is evident that dummy tensioning devices 80 are positioned on the frame 3 of the tuning device. The purpose of these dummy tensioning devices 80 is to route individual strings past the actual tuning device 1, ensuring they remain unaffected by the operation of the tuning device.

For this purpose, the respective deflection devices provided for the corresponding string are arranged in an end position such that they do not interfere with the respective strings. In other words, strings 10 arranged in the dummy clamping devices 80 are excluded from tuning.

The dummy tensioning devices 80 are designed similarly to the clamping devices 31. Both the dummy tensioning devices 80 and the clamping devices 31 feature a central opening with grooves on both sides. These grooves are designed as snap connections for corresponding plug axles, which can be pushed through openings in the loops of the string ends.

The grooves form a saddle-shaped receptacle. A similar description is also provided in relation to FIG. 22.

In FIG. 10, the tension element 28 is also visible. A set screw 27 is located on the tension element 28. By turning the set screw 27 out or in, the pre-tension can be increased or decreased. A more detailed representation can be seen in FIG. 24.

FIG. 11 shows a perspective view of an alternative embodiment of a tuning device 1. The tuning device 1 features a frame 70 in which an axis of rotation 40 is arranged. On the axis of rotation 40, a limiting element 20 and a string clamping device 30 are positioned. The frame 70 also has unspecified recesses, in which guide rollers 71 are located. A guide roller 71 is provided for each string of the string instrument 5 (refer to FIG. 1). For clarity, however, only one of the guide rollers 71 is labeled with a reference number. The guide rollers 71 enable the strings to be led out of the housing to the surface of the body 6 (see FIG. 1). A corresponding illustration is shown in FIG. 17.

A tensioning device 31 is also arranged on the string clamping device 30 for each string of the instrument 5. For clarity, however, only one of the tensioning devices 31 is provided with a reference number. An actuating lever 60 is also arranged on the string clamping device 30, which can be pivoted about the axis of rotation 40. A stop 50 for limiting the pivoting movement of the limiting element 20 is also arranged on the frame 70.

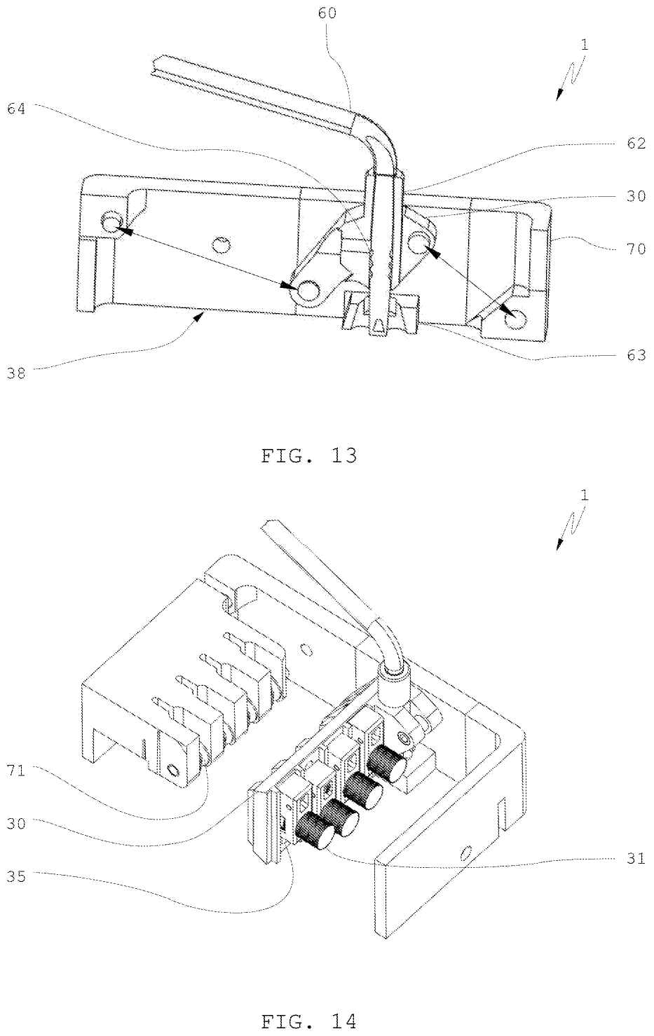

FIG. 12 shows the view from FIG. 11 in a sectional representation. This view reveals the limiting element 20. The limiting element 20 is arranged on the axis of rotation 40 and is pivotably mounted on it. Adjacent to the limiting element 20 is a stop 50. In the present illustration, the stop 50 is spaced apart from the limiting element 20 and only schematically represented. However, the stop 50 can be moved towards the limiting element 20, so that the limiting element 20 and the stop 50 are in operative connection. In this arrangement, the stop 50 limits the rotational movement of the limiting element 20 in one direction.

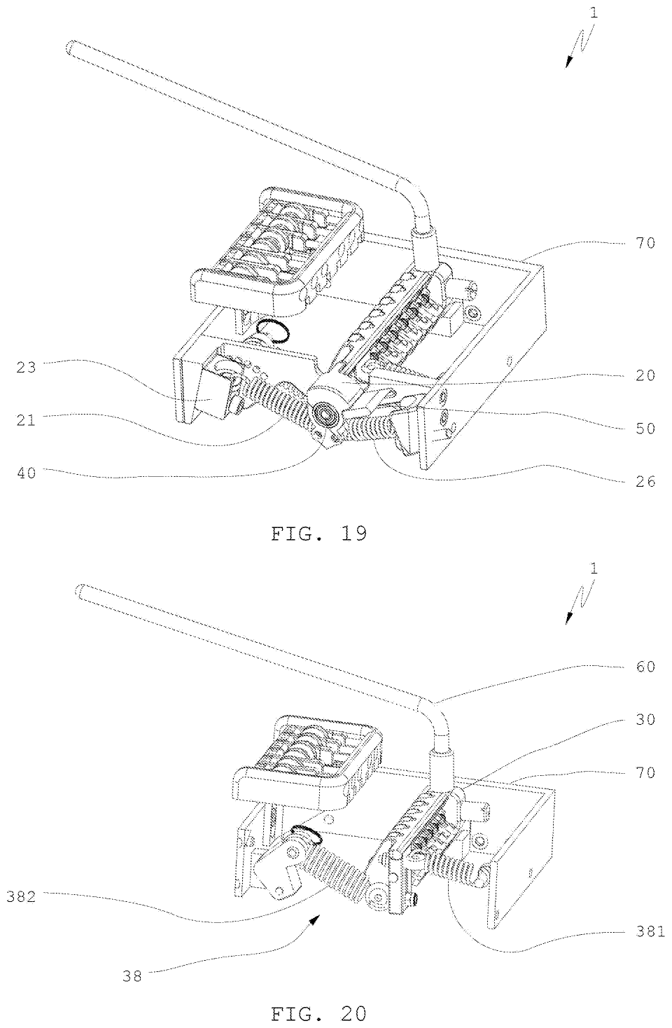

In contrast to a free-floating tuning device, this device enables simple tuning with fewer iterations. After tuning, stop 50 can be pushed away from limiting element 20 again. The tuning device is then free-floating. To center the tuning device, the biasing element 21 or the additional biasing element 26 can be pretensions almost until the tuning device is centered or balanced in the desired position (see also FIG. 19).

In the illustration shown in FIG. 12, the string clamping device 30 is held by the limiting element 20 in the position shown here against the force of the strings. In this rest position, the string clamping device 30 rests on the limiting element 20 at the stop point 25. In this case, stop point 25 is formed as the surface of an extension of limiting element 20. A corresponding stop point 37 on the string clamping device 30 is also designed as the surface of an extension of the string clamping device 30.

A fastening bolt 22 is also arranged on the limiting element 20. A biasing element 21, which is designed as a coil spring in this case, extends from the fastening bolt 22 to the retaining plate 23. The retaining plate 23 is fastened to frame 70 with a set screw 24. The fastening bolt 22 can be adjusted transversely to the axis of rotation 40 so that the suspension point of the biasing element 21 can be adjusted in relation to the axis of rotation 22. In the present embodiment, a further spring is arranged next to biasing element 21 as an additional biasing element 26, which is also fastened to fastening bolt 22.

This arrangement enables precise adjustment of the pretensioning force acting on the limiting element 22.

The adjustment screw 24 can be used to set the overall tension of the biasing element 21 and the spring of the additional biasing element 26, if present. The torques resulting from this overall tension can be precisely set by adjusting the fastening bolt 22.

Referring back to the schematic in FIG. 2A, it is evident that the force F of the biasing element 21 and the pretensioning force of strings 10 are at least balanced toward arrow P2.

However, if, for example, a string is fastened below the axis of rotation 40, as shown in FIG. 2A, the force ratios change. The force that the string clamping device 30 presses on the limiting element 20 is reduced. If the force that, in the present embodiment, acts on the string clamping device 30 below the axis of rotation becomes greater than the force that, in the present embodiment, acts above the axis of rotation, the string clamping device automatically moves into the position shown in FIG. 2B. To counteract this, the string clamping device 30 can be connected to the limiting element 20.

Alternatively, it would also be possible to provide a spring on the string clamping device 30, for example, which is adjustable in relation to the axis of rotation 40. In the event of an imbalance of the torque around the axis of rotation 40 as described here, its attachment point on the string clamping device can, for example, be adjusted in relation to the axis of rotation 40 in such a way that a replacement force is provided for the original pretensioning force of the strings.

FIG. 13 presents a cross-sectional view of the tuning device 5 from FIG. 11, focusing on the actuation lever 60. The actuation lever 60 is held in a holding element 62, which in this instance is an integral part of the string clamping device 30. The actuation lever 60 features several circumferential notches. An unspecified ball catch engages these notches 64, securing the actuation lever in a specific position. Three notches 64 are shown here, allowing the actuation lever 60 to be locked at three different heights. Also visible in FIG. 13 is a stop 63 that the actuation lever 60 engages with. Depending on the height setting of the actuation lever 60, it engages more or less deeply into the stop 63. The stop 63 is designed so that at different engagement depths of the actuation lever 60, it restricts the movement of the actuation lever 60.

FIG. 13 also illustrates two force vectors of a pretensioning device 38, each representing a spring arranged between the frame 70 and the holding element 62. In the position shown here, the force vectors or springs are arranged in such a way that they act on the string clamping device 30 against the pretensioning force of the strings. This simplifies the operation of lever 60.

A bracket can be provided for adjusting these springs, as described in FIG. 25. The force vectors correspond to the springs labeled 381 and 382 in FIG. 25.

As already explained, these springs can be replaced by a single spring that engages with the string clamping device 60 and is adjustable in relation to the axis of rotation 40 (see FIG. 12).

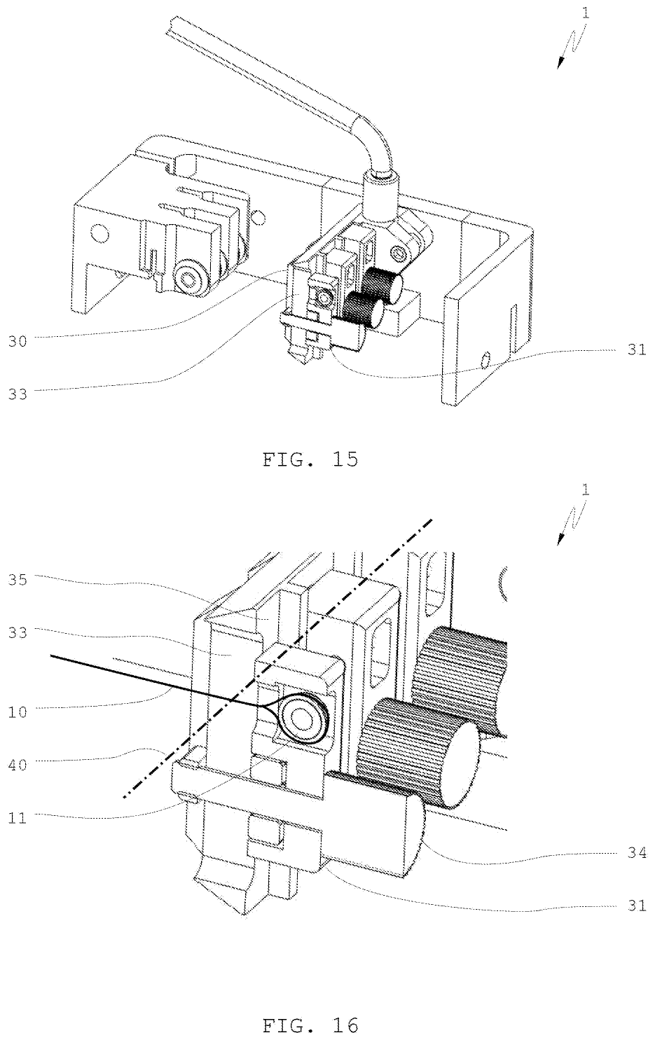

FIG. 14 shows a cross-sectional view of tuning device 1 from FIG. 11. This view shows the clamping devices 31. A clamping device 31 is arranged on the string clamping device 30 for each string of the string instrument. The tensioning devices 31 are each mounted in associated guide grooves 35. Each tensioning device 31 is assigned a a corresponding deflection roller 71 that enables the corresponding string to be guided.

FIG. 15 shows a cross-sectional view of the tuning device 1 from FIG. 11, with the section extending through the clamping device 31. In this illustration, it is clear that an elongated hole 33 is arranged in the string clamping device 30 for each string and thus for each tensioning device 31. The elongated hole 33 extends on both sides of the axis of rotation 40 (see FIG. 17).

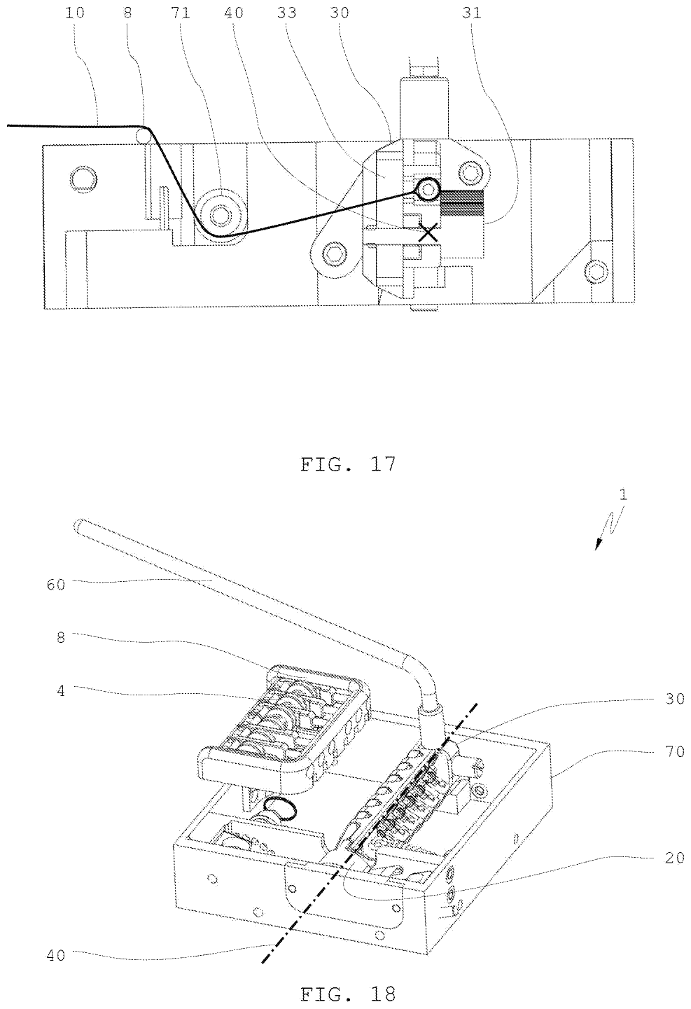

FIG. 16 shows a detailed view of FIG. 15. A string 10 is attached to the tensioning device 31 by its string end 11. The string extends through the elongated hole 33 toward the deflection pulley 71 (see FIG. 17). The tensioning device 31 is designed as an essentially rectangular body, with an adjusting screw 34 extending through the body. The adjustment screw 34 makes it possible to clamp the tensioning device 31 on the string clamping device 30.

The string clamping device 30 has several adjacent guide grooves 35 in which the respective tensioning devices 31 are mounted and can be moved.

FIG. 17 shows a side view of FIG. 15. The course of a string 10 is shown. It extends from the tensioning device 31, on which a string end 11 is held, via the deflection pulley 71 to the bridge 8, which is arranged on the body 6 of the string instrument 5 (see FIG. 1). This arrangement means that tuning device 1 can be positioned inside the body 6.

It would be conceivable to make the deflection pulleys 71 adjustable and thus enable fine tuning. Fine tuning is the adjustment of the tension of the strings at a defined clamping length. The corresponding design is explained in FIG. 23.

FIG. 18 shows an alternative embodiment of the tuning device 1 according to FIG. 11. In contrast to the embodiment shown in FIGS. 11 to 17, the tuning device 1 shown in FIG. 18 does not have any deflection rollers 71. On the other hand, the bridge 8 with the deflection rollers 4 is illustrated in FIG. 18. Bridge 8 can also be used with the tuning device 1 according to FIGS. 11 to 17. This can also be used with the tuning device shown in FIGS. 4 to 10, in particular, as an integral part of the mounting frame.

The tuning device 1 shown in FIG. 18 also differs, in particular, in the arrangement of the biasing elements and/or additional springs.

The tuning device 1, as shown in FIG. 18, has a frame 70, a string clamping device 30 and a limiting element 20. The string clamping device 30 and the limiting element 20 are mounted on the common axis of rotation 40. An actuating lever 60 is arranged on the string clamping device 30.

FIG. 19 shows the tuning device 1 as shown in FIG. 18 in a partially sectioned view. In this view, the limiting element 20 is visible. The limiting element 20 is in engagement with stop 50, which is designed to be displaceable. This stop 50 can be moved away from the axis of rotation 40 so that the limiting element 20 can freely rotate about the axis of rotation 40. This configuration facilitates simple tuning of the string instrument, as shown in FIG. 12. The tuning device can also be used in a free-floating configuration.

In the current illustration, the limiting element 20 is held by the stop 50, allowing the limiting element to pivot only in one direction. A biasing element 21, which is configured as a spring in this instance, is positioned on the limiting element 20. This spring is affixed to the limiting element with a loop and also to a pivotable mounting plate 23 on the frame 70. The pivotable mounting plate 23 facilitates the adjustment of various pretensions in the biasing element 21.

A second spring is arranged on the limiting element 20 as an additional preload element 26, which is optional.

This spring is also arranged on an unspecified mounting plate, which is also pivotable. With the spring and the preload element 21, precise adjustment of the tuning device 1 is possible, particularly in the cases described in FIG. 12. For the sake of simplicity, please refer to the description in FIG. 12 for the technical background.

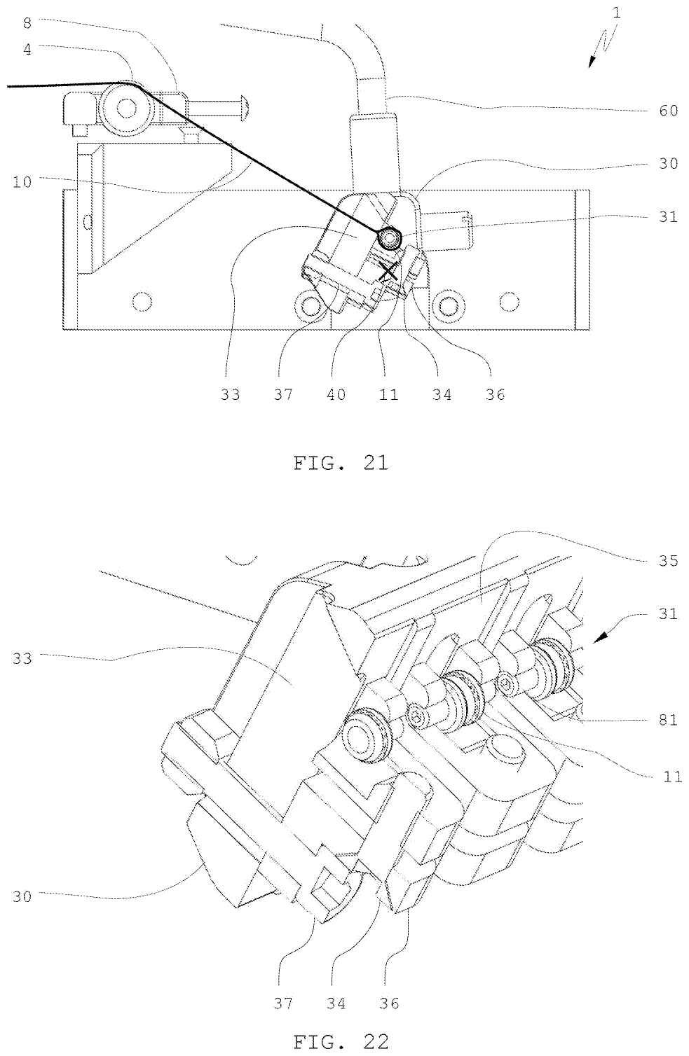

FIG. 20 shows the tuning device 1 as per FIG. 19, where the section in this illustration extends between the limiting element 20 (see FIG. 19) and the clamping device 30. Visible here is the pre-tensioning device 38, featuring two additional springs 381 and 382. This arrangement is comparable to the one shown in FIG. 13. The attachment points of springs 381 and 382 can be adjusted in relation to the axis of rotation. For this, a sliding guide is provided, in which, for example, hook screws for attaching the loops of springs 381 and 382 are arranged to be movable and fixable.

Thus, springs 381 and 382 are fastened to the string clamping device 30 in an elongated hole so that their point of application to the string clamping device can be adjusted. In addition, springs 381 and 382 are fastened to frame 70 by fastening elements not described in more detail, these fastening elements being adjustable, in particular, so that the spring force can be adjusted.

The springs 381 and 382 are arranged between the frame 70 and the tuning device 30. In the position shown here, the springs are arranged such that they act on the string clamping device 30 against the pretensioning force of the strings. This simplifies the operation of lever 60.

As already explained, these springs 381 and 382 could be replaced by a single spring that engages on the string clamping device 30 and is adjustable in relation to the axis of rotation 40 (see FIG. 12).

As an alternative to the sliding guide, springs 381 and 382 can be attached to a bracket that is adjustable in relation to the string clamping device.

This bracket can be locked in relation to the string clamping device so that it can be moved with the bracket. The points of action of the springs are on the circumference of the bracket. The forces acting on the string clamping device vary depending on the position of the bracket relative to the string clamping device. To increase the effect, the bracket can also be arranged eccentrically to the axis of rotation. A corresponding embodiment is shown in FIG. 25.

FIG. 21 shows an orthogonal sectional view of the tuning device 1, as shown in FIG. 18. The section extends through a clamping device 31. This view is comparable to that shown in FIG. 17. The axis of rotation 40 about which the string clamping device 30 can be pivoted is also visible. A string 10 is guided over the bridge 8. The bridge 8 has a deflection pulley 4. The string 10 extends from deflection pulley 4 directly to the tensioning device 31. The end of the string 10 is attached to the tensioning device 31. This attachment is explained in more detail below with reference to FIG. 22.

FIG. 21 shows that the tensioning device 31 is located at a distance from the axis of rotation 40. Therefore, pivoting of the string clamping device 30 about the axis of rotation 40 results in an extension or shortening of the distance between the return pulley 4 and the tensioning device 31.

To adjust the distance between the axis of rotation 40 and the clamping device 31, the latter has an adjusting screw 34. The adjusting screw 34 is attached to a base 36, which in turn is attached to the string clamping device 30 with a clamping element 37, which is designed as a screw in the present case.

An elongated hole 33 is provided on the string clamping device 30, which extends on both sides over the axis of rotation 40. The string 10 is guided through this elongated hole 33.

Fine adjustment of the position of the clamping element 31 in relation to the axis of rotation 40 can be made using the adjusting screw 34. The rough adjustment can be made by moving base 36 along slotted hole 33.

FIG. 22 shows a detailed perspective view of several clamping devices 31 and this representation shows a sectional view through one of the clamping devices 31.

The clamping device 31 is designed as an essentially L-shaped element. This profile has a recess or central opening in the middle with grooves on both sides that form a saddle-shaped receptacle, which is designed as a snap connection for corresponding plug-in axles 81, which can be pushed through openings in the eyelets of string ends 11. The L-shaped elements are slidably mounted in the guide grooves 35.

The L-shaped elements are attached to the base 36 with adjusting screws 34. The base 36 is in turn attached to the string clamping device 30 with a clamping element 37, which is designed as a screw. By loosening the clamping element 37, the entire arrangement can be easily moved along the slotted hole 33. This enables quick rough adjustment. For fine adjustment, the L-shaped element can also be moved precisely along the slotted hole 33 using the adjusting screw 34.

The clamping device 31 and the associated elements shown in FIG. 22 are also compatible with the embodiment of the tuning device 1 shown in FIGS. 11 to 17.

FIG. 23 shows an orthogonal sectional view of tuning device 1, as shown in FIG. 18, where this tuning device has a fine tuner 75. The section extends through a roller 76 of the fine tuner 75. This representation is comparable to the representation shown in FIG. 17.

A string 10 is guided over the bridge 8. The bridge 8 has a deflection pulley 4. The string 10 extends from deflection pulley 4 to pulley 76 of the fine tuner and from there to the tensioning device 31. The end of the string 10 is attached to the tensioning device 31. By adjusting the knurled screw, which is not described in more detail here, the tension of string 10, i.e., the entry angle of the string relative to the exit angle of the string 10, can be adjusted in relation to the roller 76 of the fine tuner 75.

The fine tuner 75 is designed such that roller 76 moves in a sliding guide and is moved axially along the thread of the knurled screw by turning the knurled screw. For this purpose, the head of the knurled screw can be connected to bridge 8 in such a way that it rests against the bridge 8 and a nut at the end of the knurled screw limits its movement. Alternatively, roller 76 can be attached to the knurled screw in a non-adjustable manner, and the adjustment can be achieved by screwing the knurled screw in or out of a corresponding thread on the bridge 8. Different heights of the respective knurled screw can be used to determine whether the strings are affected or not, i.e., whether the strings have been fine-tuned accordingly.

The fine tuner 75 is an integral part of bridge 8.

Another roller could be provided between roller 76 of the fine tuner 75 and the clamping device 31 so that the adjustment of the fine tuner has no effect on the function of the tuning device.

The fixed point of deflection pulley 4 in relation to the tuning device would then be moved behind the fine tuner.

The arrangement and design of the fastening lever 60 of the tuning device 1 according to FIGS. 18 to 22 corresponds to that described for the tuning devices 1 according to FIGS. 3 to 17 and is particularly compatible with the actuating levers 60 described therein.

The tuning device 1 according to FIGS. 11 to 22 can also be combined with deflection device 90 as described in FIGS. 3-10.

FIG. 24 shows a detailed sectional view of the tuning device 1 according to FIG. 4. The sectional view extends through the clamping element 28. The clamping element is constructed in two parts and has a fixed element 282 and a movable element 283. A wedge 284 is arranged between these and is in contact with an inclined surface of the movable element 283. This wedge 284 can be moved along the inclined surface using the thread of the adjusting screw 27. By moving wedge 284, the angle between fixed element 282 and movable element 283 can be increased or decreased. The biasing element 21, which is not shown here, is attached to the movable element 283 (see, for example, FIG. 2A), which pulls the clamping element 28 as a whole toward stop 50. It is evident that a distance between the stop 50 and the movable element 283 is increased or decreased by adjusting the wedge 284. Accordingly, tension in the pretension element 21 is increased or decreased when the fixed element, as shown here, is in contact with the stop 50. However, if the movable element 283 is in contact with the stop 50, the overall tension of all strings can be adjusted.

The tension element 28 is in this case an integral part of the boundary element 20 (see, for example, FIG. 5).

FIG. 25 shows a detailed view of an alternative embodiment of the tuning device, as shown in FIG. 20. A bracket for simple adjustment of the spring tension is shown. This can be an alternative embodiment of the pretensioning device 38, as shown in FIG. 20. The bracket can be designed as a two-part locking disk 55. In this case, one half 552 of the locking disk 55 is rigidly connected to the string clamping device 30 and the second half 551 of the locking disk 55 can have corresponding fastening elements 554 and 555 as points of attachment for the springs 381 and 382. The two parts 554 and 555 of the locking disk can be pressed together by a preloaded spring 553, so that they can only rotate relative to each other when a certain force is applied. The pretension of spring 553 can be adjusted via nut 556. The part 551 of the locking disk with the points of attachment 554 and 555 can be adjusted accordingly, for example, with a lever tool, so that the spring force of the springs 381 and 382 on the string clamping device 1 changes.

It is evident that the device shown in FIG. 25 is compatible with all embodiments and can be used with all springs and/or biasing elements. Two points of attachment are not necessary. The bracket shown in FIG. 25 can also act only on one spring or one biasing element.

FIG. 26 shows a sectional view through a bridge 8 of a tuning device. The bridge 1 has an adjustable pulley 4 along the string 10 for each string 10. To adjust the pulley 4, an adjusting screw 85 is provided.

This adjusting screw 85 engages in a threaded bore 89 in a holder 87 in which the pulley 4 is mounted. The holder 87 has two set screws 88 to adjust the height of the pulley 4 in relation to the body of the stringed instrument. The adjusting screw 85 is oriented substantially in the direction of the string 10 and is under pressure, opposing the string tension and experiencing a compressive load. To securely hold the adjusting screw 85, a spherical receptacle is provided in the bridge, and the adjusting screw 85 has a matching spherical head 86 for this purpose. The adjusting screw 85 is thus spherical in its bearing. It is provided that the bridge (8) in this area is constructed in two parts, and the spherical receptacle is formed half in each of the corresponding parts. This allows the spherical head to be inserted into these two halves and then screwed together so that the adjusting screw 85 is securely held.

This embodiment of the bridge makes it possible to create additional space between the bridge 8 and the other elements of the tuning device, for example, for the movement of the string clamping device and/or the limiting element.

It is understood this bridge 8 can be combined with all embodiments of the disclosed tuning devices 1.

FIG. 27 shows clamping device 31 as an alternative to the clamping device 31 shown in FIG. 22.

To adjust the distance between the axis of rotation 40 and the tensioning device 31, the latter has an adjusting screw 34. This adjusting screw 34 is arranged on two cams projecting from the string clamping device 30 so that it can be rotated about its longitudinal axis but is fixed in its axial position.

An elongated hole 33 is provided on the string clamping device 30, which extends on both sides over the axis of rotation 40. The string 10 is guided through this elongated hole 33.

The position of the clamping element 31 in relation to the axis of rotation 40 can be adjusted using the adjusting screw 34.

The clamping device 31 is essentially designed as a U-shaped profile, whereby it has several recesses in its flanks that form saddle-shaped receptacles, which are designed as snap-in connections for corresponding plug-in axles 81, which can be pushed through openings in the eyelets of string ends 11.

An internal thread is arranged on the side of this U-shaped profile, which interacts with the adjusting screw 34. By turning the adjusting screw 34, the U-shaped profile and thus an eyelet of a string, which is held in the saddle-shaped holder by a plug-in axle 81, can therefore be moved along the elongated hole 33 and thus a distance from the axis of rotation 40 can be set.

FIG. 28 shows a sectioned perspective view of an alternative bridge 8 of a tuning device, which is essentially analogous to FIG. 26, but mirror-inverted. Bridge 1 has one pulley 4 per string (not shown here) that can be adjusted along the string. To adjust the deflection pulley 4, it is intended to be mounted so that it can be moved in a corresponding guide on the bridge 8. For this purpose, return pulley 4 is mounted in holder 87. The holder 87 has four adjustable elements, which are designed as set screws 88 to adjust the height of the pulley 4 relative to the body of the string instrument. A screw 85′ is provided for fixing the holder, which engages from below through the bridge 8 and engages in a corresponding threaded hole on the holder 87.

The clamping device 31 and the associated elements shown in FIG. 22 are also compatible with the embodiment of the tuning device 1 shown in FIGS. 11 to 21.

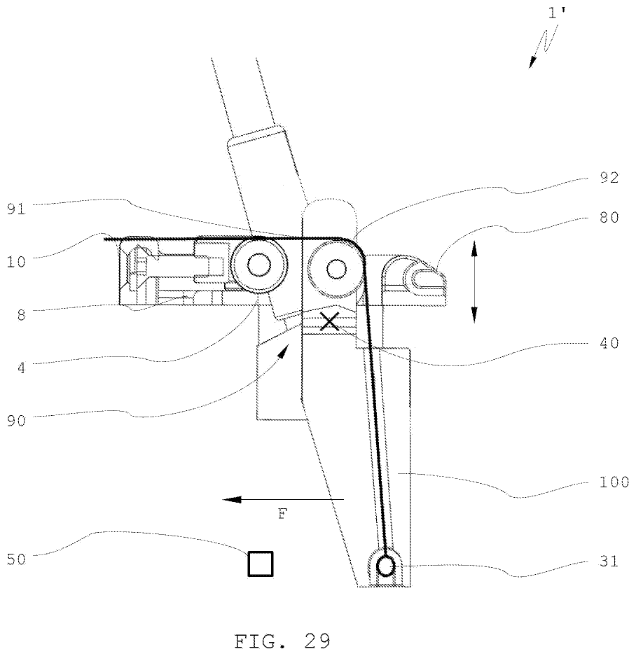

FIG. 29 shows an alternative embodiment of a tuning device 1′, analogous to the depiction in FIG. 6. The tuning device 1′ according to FIG. 29 features a block 100 instead of a separate limiting element and a separate string clamping device. This block 100 is pivotally mounted on a rotational axis 40. There is a deflection device 90 On the block 100, which is adjustable in relation to the rotational axis 40, as indicated by the double arrow. The deflection device 90 includes a deflection pulley 92 and is mounted in an elongated hole, similar to the description above. This elongated hole can be open on one side, especially, according to the depiction in FIG. 29, upwards. Additionally, a clamping mechanism 31 is arranged on the block 100. It is positioned opposite to the rotational axis 40 of the deflection device 90.

The rotational axis 40 is arranged on a mounting frame 3, which also provides a bridge 4, on which the strings 10, not shown here for simplicity, are placed. The bridge 8 has a movable deflection pulley 4 for each string. The vibrating length of each string can be individually adjusted with these deflection pulleys 4. Corresponding deflection pulleys are shown in FIG. 28.

There can be dummy tensioning devices 80 arranged on the frame 3 of the tuning device, as shown in FIG. 29. The dummy tensioning devices 80 are intended to guide individual strings past the actual tuning device 1′, so they remain unaffected by the operation of the tuning device 1′. For this purpose, the respective deflection devices 90 intended for the corresponding string are arranged in an end position, so they do not interfere with the respective string.

In other words, strings 10 that are arranged in the dummy tensioning devices 80 are excluded from tuning.

The dummy tensioning devices 80 are designed similarly to the clamping mechanisms 31. They can be designed as already described. In this case, both the dummy tensioning devices 80 and the clamping mechanisms 31 have a central opening with grooves on both sides, which are designed as a snap connection for corresponding plug-in axles that can be pushed through openings of the string ends' eyelets. The grooves form a saddle-shaped receptacle. A corresponding description can also be found for FIG. 22.

The tuning device 1′ is shown in an activated state in FIG. 29. Accordingly, the block 100 is distanced from a stop 50. In the deactivated state, the block 100 is drawn towards the stop 50 by a biasing element 21. The biasing element 21 is illustrated here by the force vector F.

The statements made in the present description regarding the stop 50 and the biasing element are analogously applicable.

The configuration according to FIG. 29 could, for example, also be incorporated into the embodiment according to FIG. 6. This would allow individual strings to be tuned only in one direction if they are clamped to the block (100) and other strings to be tuned in both directions if they are clamped as shown in FIG. 6. In the former case, the strings would be guided over the deflection device as shown in FIG. 29.

In alternative embodiments, instead of tension springs as shown in the figures, compression springs can also be used. Both tension springs and compression springs can be designed as coil springs. For compression springs, wave springs or disc springs can also be used. Alternatively, torsion springs, helical springs, or spiral springs may be suitable, or even simple leaf springs that are, for example, clamped on one side to the string clamping device or the limiting element and rest on a corresponding abutment.

1. A tuning device (1) for a string instrument (5), comprising a limiting element (20) and a string clamping device (30), wherein the limiting element (20) and the string clamping device (30) are pivotally mounted independently of one another, particularly on a common axis of rotation (40), and wherein that the tuning device (1) has a stop (50) for limiting the pivoting movement of the limiting element (20).

2. The tuning device (1) according to claim 1, wherein the limiting element (20) is held in contact with the stop (50) with a biasing element (21), in particular a spring.

3. The tuning device (1) according to claim 1, wherein a tensioning element (28) for adjusting the biasing element (21) or a string tension is arranged on the limiting element (20).

4. The tuning device (1) according to claim 3, wherein the tensioning element (28) has a fixed element (282) and a movable element (283) which are spaced apart from one another by an adjustable wedge (284).

5. The tuning device (1) according to claim 1, wherein the string clamping device (30) has at least one tensioning device (31) for fastening a string (10), particularly at a variable distance from the axis of rotation (40).

6. The tuning device (1) according to claim 1, wherein the string clamping device (30) has at least one elongated hole (33), this elongated hole (33) extending, in particular, over the axis of rotation (40) and on both sides thereof, and the clamping device (31) for receiving a string end (11) has a saddle-shaped seat that is arranged displaceably along the elongated hole (33).

7. The tuning device (1) according to claim 6, wherein an associated plug-in axle (81) can be inserted into the saddle-shaped seat, which forms a snap connection with the saddle-shaped seat.

8. The tuning device (1) according to claim 6, wherein the saddle-shaped seat is displaceable along the slotted hole (33) with an adjusting screw (34).

9. The tuning device (1) according to claim 1, wherein the limiting element (20) has at least one deflection device (90) for deflecting a string (10), particularly at a variable distance from the axis of rotation (40).

10. The tuning device (1) according to claim 9, wherein the deflection device (90) has an elongated hole (91), the elongated hole (91) extending, in particular, over the axis of rotation (40) and on both sides thereof, and the deflection device (31) has a deflection roller (92) that is arranged displaceable along the elongated hole (91), wherein in particular the deflection pulley (92) is displaceable along the elongated hole (91) with an adjusting screw (93).

11. The tuning device according to (1) claim 1, further comprising a bridge (8) for supporting the strings (10).

12. The tuning device (1) according to claim 11, wherein the bridge (1) has one deflection pulley (4) per string (10) that can be adjusted along the string (10), the deflection pulley (4) being arranged on a holder (87).

13. The tuning device (1) according to claim 12, wherein an adjusting screw (85) acting against the string tension, is provided for adjusting the return pulley (4), wherein the adjusting screw (85) preferably has a spherical head (86), which is spherically mounted in the bridge (8).

14. The tuning device (1) according to claim 1, wherein the tuning device has one deflection pulley (71) per string (10), which is designed, in particular, as an adjustable pulley (76) for adjusting the string tension.

15. The tuning device (1′) for a string instrument (5) with a block (100), where the block (100) is pivotally mounted about a rotational axis (40), wherein the block (100) features a deflection device (90) for redirecting a string (10), wherein the deflection device (90) is arranged adjustable in relation to the rotational axis (40) of the tuning device (1′) and perpendicular to this axis.

16. The tuning device (1′) according to claim 15, wherein the deflection device (90) includes a deflection pulley (92).

17. The tuning device (1′) according to claim 15, wherein a clamping mechanism (31) is arranged on the block (100).

18. The tuning device (1′) according to claim 15, wherein the clamping mechanism (31) is positioned opposite in relation to the rotational axis (40) of the deflection device (90).

19. The tuning device (1′) according to claim 15, wherein the tuning device (1′) includes a stop (50) for limiting a pivoting movement of the limiting element (20).

20. The tuning device (1′) according to claim 19, wherein the block (100) is held in contact with the stop (50) by a biasing element (21), particularly a spring.

21. A string instrument (5), particularly a guitar, comprising a tuning device according to claim 1.
